(19) United States
(12) Patent Application Publication
(10) Pub. No.: US 2010/0148840 A1
(43) Pub. Date: Jun. 17, 2010

(54) PULSE MODULATED CHARGE PUMP CIRCUIT

(76) Inventors: SIYOU WENG, Palo Alto, CA (US); TACETTIN ISIK, Saratoga, CA (US)

Correspondence Address: HAYNES AND BOONE, LLP;IP Section, 2323 Victory Avenue, Suite 700, Dallas, TX, 75219, US

(21) Appl. No.: 12/336,387

(22) Filed: Dec. 16, 2008

(51) Int. Cl. G05F 1/10; G06F 1/04

(52) U.S. Cl. 327/291; 327/536

(57) ABSTRACT

A circuit for increasing a gate voltage of a transmission gate in a high-speed switch to a level higher than a level of a supply voltage is provided. The circuit includes an oscillator generating a clock signal and a charge pump circuit operatively coupled to the oscillator. The charge pump circuit receives the supply voltage and the clock signal as inputs, and outputs the gate voltage. The circuit also includes a comparator circuit coupled to the oscillator circuit and the charge pump circuit and a pulse signal generator circuit operatively coupled to the oscillator, the pulse signal generator circuit generating a pulse signal which enables the oscillator.

### TECHNICAL FIELD

The present invention is related to increasing the voltage of a transmission gate in a high-speed switch, and, in particular, to a pulse modulated charge pump.

### DISCUSSION OF RELATED ART

In typical high-speed switch design, a transmission gate is often used. A transmission gate is typically a CMOS-type switch which uses one PMOS and one NMOS FET connected in parallel, wherein the gate voltage controls the operation of the switch. The on resistance of the switch is proportional to the width of the gate and the drive voltage of the gate. However, increased gate width also means increased parasitic capacitance of the switch, which may result in the switch having lower bandwidth. Accordingly, to decrease the parasitic capacitance, and, in turn increase the bandwidth of the transmission gate an NMOS FET is most often used in the transmission gate in high speed applications. However, this often results in a gate having a reduced gate width, and a higher on resistance. To decrease the on resistance, the gate voltage of the transmission gate is typically increased, or “pumped,” to a level which is higher than a power supply voltage. FIG. 1 illustrates a typical circuit 100 for increasing, or “pumping,” the voltage.

As shown in FIG. 1, voltage pumping circuit 100 includes an oscillator 102 coupled to a charge pump circuit 104. Charge pump circuit 104, in response to a clock signal from the oscillator and a supply voltage V_{DD}, produces an output voltage Vₒᵤₜ having a higher voltage level than supply voltage V_{DD}. Output voltage Vₒᵤₜ may be utilized as the gate voltage, or at least is proportional to the gate voltage, in a high-speed switch. Charge pump circuit 104 may be one of many known charge pump circuits, including a charge pump described in Dickson, J., “On-chip high-voltage generation in MNOS integrated circuits using an improved voltage multiplier technique,” IEEE J. Solid States Circuit, Vol. 11, No. 6, June 1976, pp. 374-378, otherwise known as a Dickson's charge pump. Charge pumps are typically circuits that generate a voltage larger than the supply voltage from which they operate.

However, in using the configuration shown in FIG. 1, it is difficult to regulate output voltage Vₒᵤₜ. Often, a higher output voltage Vₒᵤₜ is generated than is needed or desired. Moreover, in the circuit of FIG. 1, oscillator 102 and charge pump circuit 104 are always on and constantly consuming power. Therefore, the power consumption of circuit 100, and therefore circuit 100, is typically very inefficient.

In some cases, a feedback loop may be added, that can control the operation of oscillator 102 and charge pump 104 so that they operate only when necessary. FIG. 2 illustrates a voltage pumping circuit 200 according to another conventional arrangement. As shown in FIG. 2, a level-shift comparator circuit 202 is coupled to oscillator circuit 102 to provide an input signal to oscillator circuit 102. Comparator circuit 202 is also coupled to receive an output signal from charge pump circuit 104, comparator circuit 202 sampling output voltage Vₒᵤₜ, and to provide a feedback to oscillator 102 in the form of an enable signal. In operation, a predetermined target voltage Vₜ is input into comparator circuit 202 as a reference. The sampled output voltage Vₒᵤₜ is compared with predetermined target voltage Vₜ such that, when Vₒᵤₜ is less than Vₜ, the enable signal is output to oscillator 102. Oscillator 102 outputs the clock signal to charge pump circuit 104 to provide an increased output voltage Vₒᵤₜ in response to the enable signal.

However, in voltage pumping circuit 200, comparator 202 is constantly operating, comparing output voltage Vₒᵤₜ with target voltage Vₜ, and thus is continually consuming power. Moreover, the sensitivity and speed of comparator 202 is proportional to its operating DC current. Thus, in order to maintain the low on-state resistance of a high-speed switch, and consequently the high-speed operation of the switch, comparator 202 is continually consuming a large DC current.

There is therefore a need to provide a charge pump circuit for use in a high-speed switch having lower power consumption.

### SUMMARY

In accordance with aspects of the present invention, there is provided a circuit, comprising an oscillator generating a clock signal; a charge pump circuit operatively coupled to the oscillator and receiving a supply voltage and the clock signal as inputs; and a pulse voltage generator circuit operatively coupled to the oscillator, the pulse voltage generator circuit generating a pulse signal to enable the oscillator and modulate the charge pump circuit.

In accordance with aspects of the present invention, there is also provided a circuit for increasing a gate voltage of a transmission gate in a high-speed switch to a voltage higher than a level of a supply voltage, comprising an oscillator generating a clock signal; a charge pump circuit operatively coupled to the oscillator, the charge pump circuit receiving the supply voltage and the clock signal as inputs and outputting the gate voltage; a comparator circuit coupled to the oscillator circuit and the charge pump circuit; and a pulse signal generator circuit operatively coupled to the oscillator, the pulse signal generator circuit generating a pulse signal to enable the oscillator and modulate the charge pump circuit.

In accordance with aspects of the present invention there is further provided a method of increasing a voltage of a transmission gate in a high-speed switch, comprising generating a pulse signal at a predetermined or adaptive frequency and pulse width; generating a clock signal at predetermined intervals in response to the generated pulse signal; and increasing the voltage of the transmission gate in response to the generated clock voltage.

These and other embodiments will be described in further detail below with respect to the following figures.

### BRIEF DESCRIPTION OF THE DRAWINGS

FIGS. 1 and 2 illustrate charge pump circuits according to the prior art.

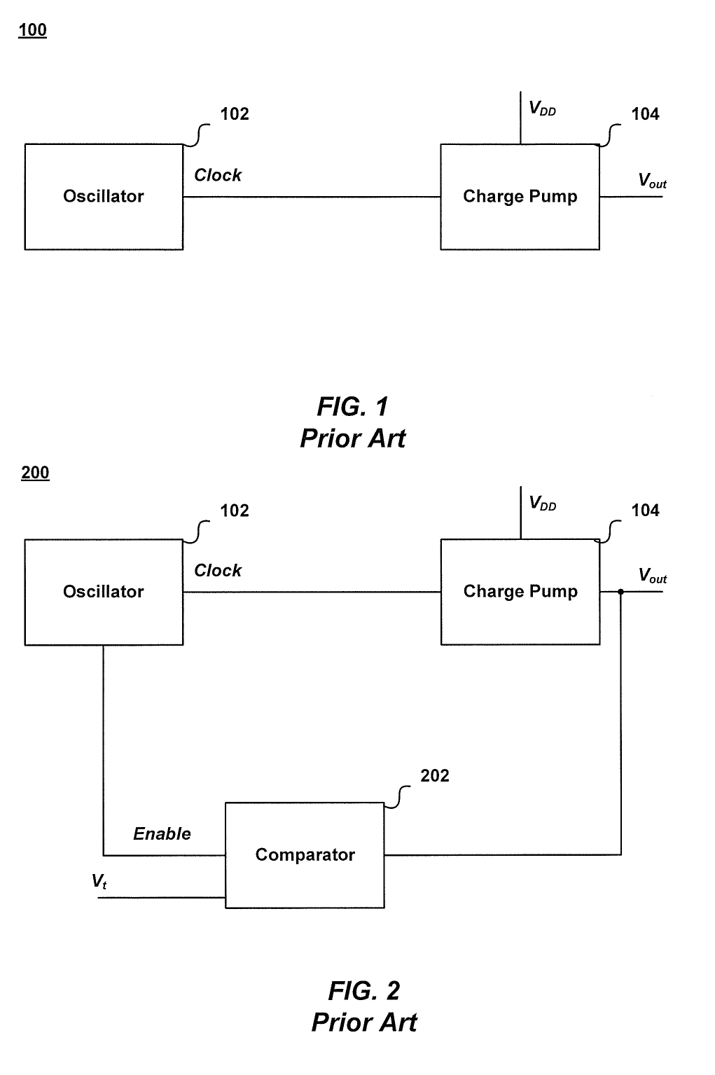

FIG. 3 shows a diagram illustrating a voltage increasing circuit according to another embodiment of the present invention.

FIG. 4 shows a diagram illustrating a voltage increasing circuit according to another embodiment of the present invention.

FIG. 5 shows a flowchart illustrating a method for increasing a voltage of a transmission gate in a high-speed switch, consistent with embodiments of the present invention.

FIG. 6 shows a diagram illustrating a voltage increasing circuit according to an embodiment of the present invention using a Dickson charge pump.

FIG. 7 shows a diagram illustrating a voltage pumping circuit coupled to a transmission gate of a high-speed switch, consistent with the present invention.

In the drawings, elements having the same designation have the same or similar functions.

### DETAILED DESCRIPTION

In the following description specific details are set forth describing certain embodiments of the invention. It will be apparent, however, to one skilled in the art that the present invention may be practiced without some or all of these specific details. The specific embodiments presented are meant to be illustrative of the present invention, but not limiting. One skilled in the art may realize other material that, although not specifically described herein, is within the scope and spirit of this disclosure.

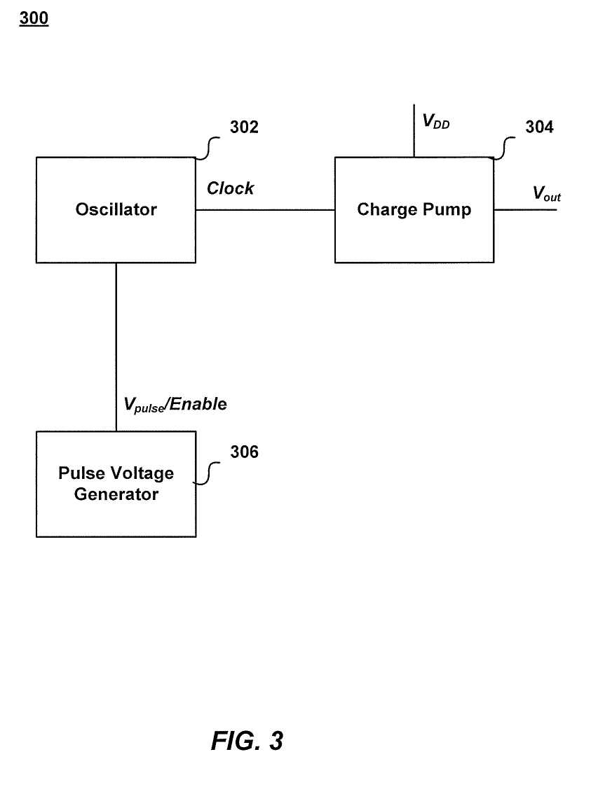

FIG. 3 is a diagram illustrating a voltage pumping circuit 300 according to an embodiment consistent with the present invention. As shown in FIG. 3, voltage pumping circuit 300 includes an oscillator 302 coupled to a charge pump circuit 304. Charge pump circuit 304 receives a clock signal from the oscillator and a supply voltage V_{DD}, and outputs an output voltage Vₒᵤₜ having a higher level than V_{DD}. Voltage pumping circuit 300 also includes a pulse voltage generator 306 coupled to an input of oscillator 302. Consistent with the present invention, pulse voltage generator 306 periodically outputs a pulse signal, which is input to oscillator 302 to modulate charge pump circuit 304. According to some embodiments of the present invention the pulse signal may include a low-power, low-frequency pulse voltage Vₚᵤₗₛₑ. Moreover, pulse voltage Vₚᵤₗₛₑ may be output by pulse voltage generator 306 at a predetermined or adaptive frequency and pulse width, or when certain circuit conditions are satisfied.

Consistent with the present invention, pulse voltage Vₚᵤₗₛₑ provides an enabling signal, or triggering signal, to oscillator 302, such that when oscillator 302 receives pulse voltage Vₚᵤₗₛₑ a clock signal may be generated and input into charge pump circuit 304 to modulate charge pump circuit 304. Accordingly, oscillator 302 and charge pump 304 are only operated in response to the periodic pulse voltage Vₚᵤₗₛₑ. Thus, oscillator 302 and charge pump 304 are not constantly operating, as in the prior art, which may provide a voltage pumping circuit 300 having greater efficiency and decreased power consumption.

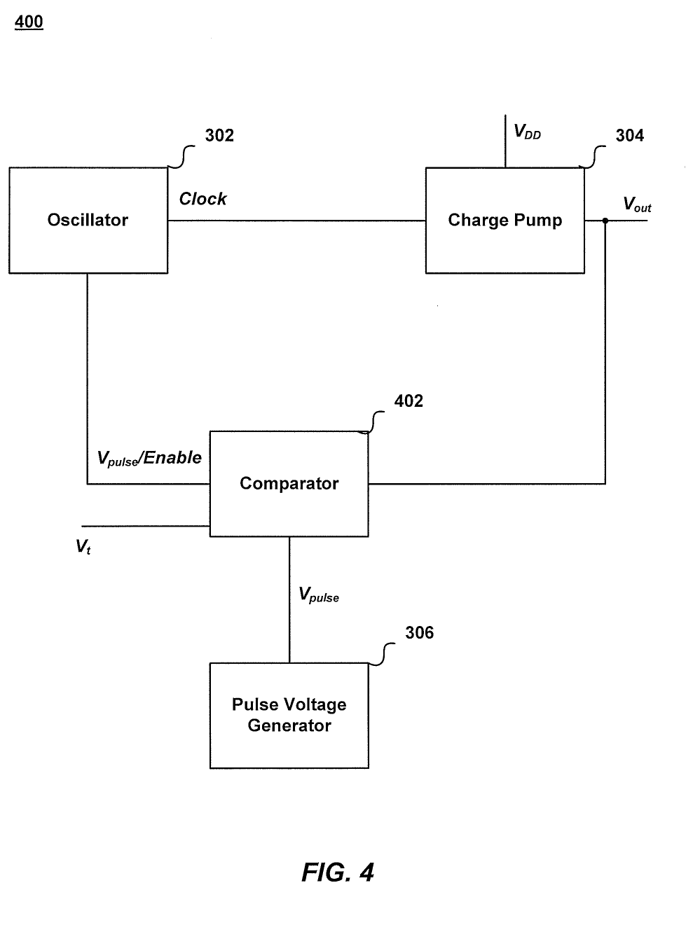

FIG. 4 is a diagram illustrating a voltage pumping circuit 400 according to another embodiment of the present invention. Voltage pumping circuit 400 is similar to the voltage pumping circuit 300 shown in FIG. 3, with the addition of a comparator circuit 402 coupled between oscillator 302 and pulse voltage generator 306. Comparator circuit 402 is also coupled to an output of charge pump circuit 304 for sampling output voltage Vₒᵤₜ and providing a feedback in the form of an enable signal along with voltage pulse Vₚᵤₗₛₑ. In accordance with embodiments of the present invention, a predetermined target voltage Vₜ is input into comparator circuit 402 as a reference. The sampled output voltage Vₒᵤₜ is compared with predetermined target voltage Vₜ, such that when Vₒᵤₜ is less than Vₜ, the Vₚᵤₗₛₑ/enable signal is output to oscillator 302. The Vₚᵤₗₛₑ/enable signal triggers oscillator 302, which outputs the clock signal to charge pump circuit 304 to provide an increased output voltage Vₒᵤₜ. However, consistent with embodiments of the present invention, comparator circuit 402 only operates when pulse voltage Vₚᵤₗₛₑ is generated by pulse voltage generator circuit 306 and received by comparator circuit 402. Accordingly, comparator circuit 402 is not constantly consuming power, resulting in a voltage pumping circuit 400 with increased efficiency and decreased power consumption. Moreover, because voltage pulse Vₚᵤₗₛₑ generator could be made which consumes a current of less than about 1 μA, comparator circuit 402 may be a zero DC current comparator which consumes essentially no DC current.

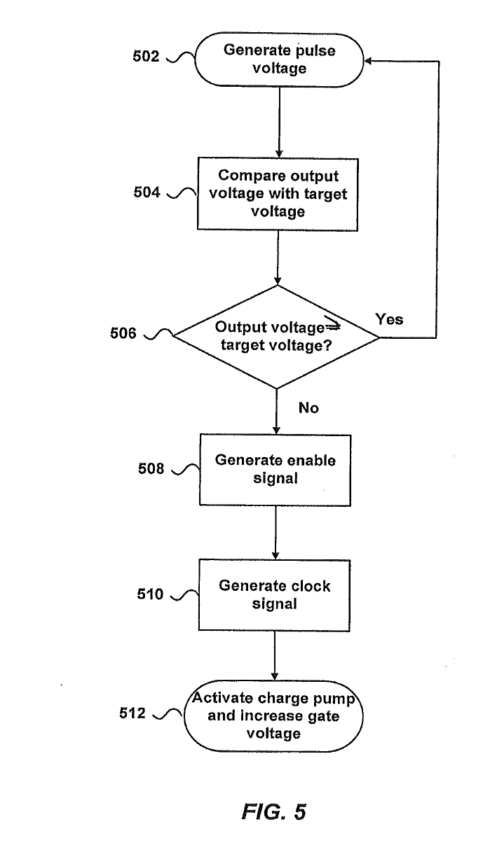

FIG. 5 shows a flowchart illustrating a method for pumping a voltage of a transmission gate in a high-speed switch, consistent with embodiments of the present invention, and will be discussed with reference to voltage pumping circuit 400 shown in FIG. 4. As shown in FIG. 5, pulse voltage Vₚᵤₗₛₑ is generated by pulse voltage generator 306 (step 502). Pulse voltage Vₚᵤₗₛₑ is received as an input by comparator circuit 402, providing a signal to comparator circuit 402 that turns comparator circuit 402 on. Comparator circuit 402 then compares output voltage Vₒᵤₜ with predetermined target voltage Vₜ (step 504). Comparator circuit 402 makes a determination as to whether output voltage Vₒᵤₜ is less than predetermined target voltage Vₜ (step 506). If output voltage Vₒᵤₜ is equal to or greater than predetermined target voltage Vₜ, output voltage Vₒᵤₜ is at the correct voltage. Another comparison will be made during a subsequent interval when the next pulse voltage Vₚᵤₗₛₑ is generated (step 502). If output voltage Vₒᵤₜ is less than target voltage Vₜ, comparator circuit 402 generates an enable signal (step 508), which can include pulse voltage Vₚᵤₗₛₑ, to oscillator 302, triggering oscillator 302. Oscillator 302 then may generate a clock signal (step 510) which is input into charge pump circuit 304, activating charge pump circuit 304 to increase the gate voltage (step 512).

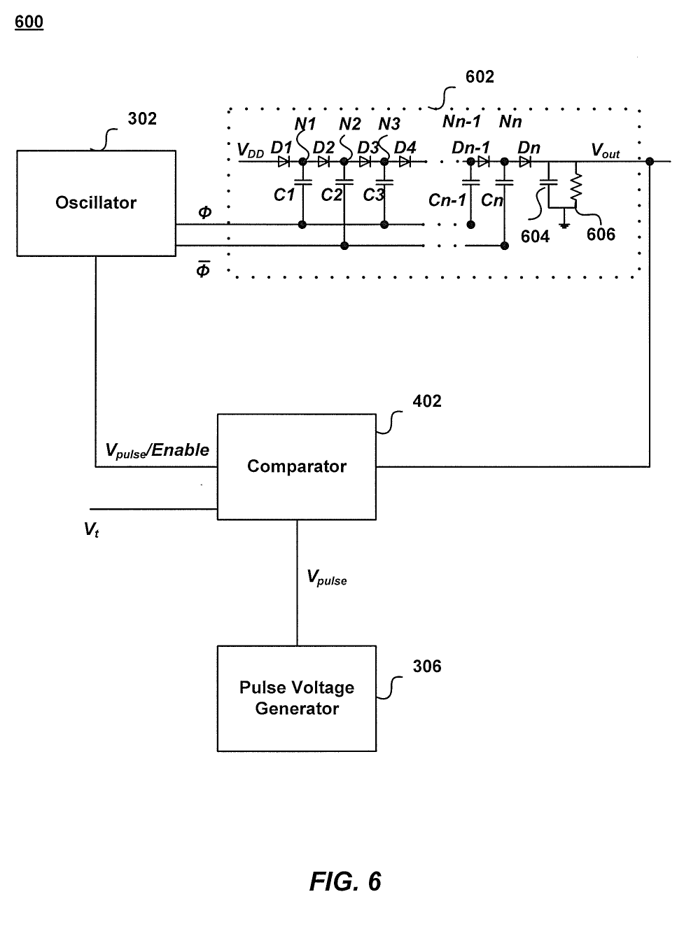

FIG. 6 shows a diagram illustrating a voltage pumping circuit 600 according to some embodiments of the present invention using a Dickson charge pump. Voltage pumping circuit 600 is similar to voltage pumping circuit 400, with the specific inclusion of a Dickson charge pump 602 as the charge pump circuit. As shown in FIG. 6, when pulse voltage generator 306 generates pulse voltage Vₚᵤₗₛₑ, comparator circuit 402 compares sampled output voltage Vₒᵤₜ with predetermined target voltage Vₜ, such that when Vₒᵤₜ is not equal to or greater than Vₜ, the Vₚᵤₗₛₑ/enable signal is output to oscillator 302. The Vₚᵤₗₛₑ/enable signal triggers oscillator 302, which outputs the clock signal to charge pump circuit 304 to provide an increased output voltage Vₒᵤₜ. In accordance with some embodiments of the present invention, oscillator 302 generates a clock signal having two phases. That is, oscillator 302 generates a first clock signal having a first phase φ and a second clock signal having a second phase φ̅, each having a voltage amplitude of V_{Φ}, which are input into charge pump circuit 602. As shown in FIG. 6, charge pump circuit 602 comprises diodes D1-Dn coupled to capacitors C1-Cn, which are coupled to an RC circuit including capacitor 604 and resistor 606. In operation, charge is pumped along diodes D1-Dn as capacitors C1-Cn are successively charged and discharged during each clock cycle. When clock phase φ goes low, diode D1 conducts until the voltage at the node N1 becomes equal to the input voltage Vᵢₙ minus the voltage across the diode V_{d}. When first clock signal φ having voltage amplitude V_{Φ} is input into diode D1, the voltage at node N1 becomes Vᵢₙ+(V_{Φ}−V_{d}), which causes diode D2 to conduct until the voltage at node N2 becomes Vᵢₙ+(V_{Φ}−V_{d})−V_{d}. After N stages, output voltage Vₒᵤₜ will be equal to Vᵢₙ+n·(V_{Φ}−V_{d})−V_{d}. Assuming capacitors C1-Cn have the same capacitance C, and taking into account the effects of stray capacitance C_{S}, a current Iₒᵤₜ generated across resistor 606, and the operating frequency f of charge pump circuit 602, output voltage Vₒᵤₜ becomes

$${V}_{out} = ( {V}_{i n} - {V}_{d} + n \cdot ( \frac{C}{C + {C}_{s}} \cdot {V}_{φ} - {V}_{d} ) ) - ( \frac{{I}_{out} \cdot n}{( C + {C}_{s} ) \cdot f} ) ,$$

as is discussed in Dickson, J., “On-chip high-voltage generation in MNOS integrated circuits using an improved voltage multiplier technique,” IEEE J. Solid States Circuit, Vol. 11, No. 6, June 1976, pp. 374-378. Charge pump circuit 602 using a Dickson charge pump, as shown in FIG. 6, is one example of a charge pump that may be used in embodiments consistent with the present invention. Other charge pump circuits, such as voltage doublers, and static CTS charge pumps may also be used as charge pump circuit 602 in voltage pumping circuit 600.

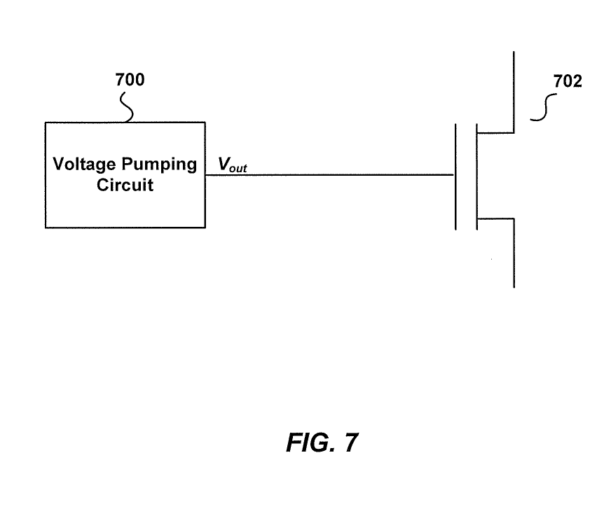

FIG. 7 shows a diagram illustrating a voltage pumping circuit 700 coupled to a transmission gate 702 of a high-speed switch, consistent with the present invention. As shown in FIG. 7, voltage pumping circuit 700 may be used to pump a gate voltage of a transmission gate 702 in a high-speed switch, such as may be used in devices adhering to the USB or USB 2.0 protocol. Consistent with embodiments of the present invention, voltage pumping circuit may be any of the voltage pumping circuits 300, 400, or 600, as described herein.

In accordance with aspects of the present invention, a voltage increasing circuit as described herein, may be driven by a low-power, low-frequency pulse voltage. The low-power, low-frequency pulse voltage provides a periodic driving signal to drive an oscillator and a charge pump circuit. Accordingly, embodiments consistent with the present invention may provide a voltage increasing circuit which is efficient and consumes little power.

For illustrative purposes, embodiments of the invention have been specifically described above. This disclosure is not intended to be limiting. Therefore, the invention is limited only by the following claims.

1. A circuit, comprising:
an oscillator generating a clock signal;
a charge pump circuit operatively coupled to the oscillator and receiving a supply voltage and the clock signal as inputs;
a pulse signal generator circuit generating a pulse signal; and
a comparator circuit coupled between the oscillator and the pulse signal generator circuit, the comparator circuit receiving the pulse signal as an input, and outputting an enable signal to the oscillator.

2. The circuit of claim 1, wherein the pulse signal comprises a low-power, low-frequency pulse voltage.

3. (canceled)

4. The circuit of claim 1, wherein:
the comparator circuit is further coupled to the charge pump circuit;
the comparator circuit samples an output voltage from the charge pump circuit and compares the output voltage and a predetermined target voltage; and
the comparator circuit outputs the enable signal to the oscillator circuit when the sampled voltage is less than the predetermined target voltage.

5. The circuit of claim 4, wherein the comparator comprises a zero-DC current comparator.

6. The circuit of claim 1, wherein the clock signal comprises a first clock signal having a first phase and a second clock signal having a second phase.

7. The circuit of claim 1, wherein the charge pump circuit comprises a Dickson's charge pump circuit.

8. The circuit of claim 1, wherein the charge pump circuit is coupled to a transmission gate, the transmission gate being used in a high-speed switch.

9. The circuit of claim 2, wherein the low-power, low-frequency pulse voltage is output with a predetermined or adaptive frequency and pulse width.

10. A circuit for increasing a gate voltage of a transmission gate in a high-speed switch to a level higher than a level of a supply voltage, comprising:
an oscillator generating a clock signal;
a charge pump circuit operatively coupled to the oscillator, the charge pump circuit receiving the supply voltage and the clock signal as inputs, and outputting the gate voltage;
a comparator circuit coupled to the oscillator circuit and the charge pump circuit; and
a pulse signal generator circuit operatively coupled to the comparator, the pulse signal generator circuit generating a pulse signal to enable the oscillator and modulate the charge pump circuit through the comparator.

11. The circuit of claim 10, wherein the comparator circuit samples the output voltage and compares the sampled output voltage with a predetermined target voltage, and outputs an enable signal when the sampled voltage is less than the predetermined target voltage.

12. The circuit of claim 11, wherein the comparator comprises a zero- DC current comparator.

13. The circuit of claim 10, wherein the clock signal comprises a first clock signal having a first phase and a second clock signal having a second phase.

14. The circuit of claim 10, wherein the charge pump circuit comprises a Dickson's charge pump circuit.

15. The circuit of claim 10, wherein the pulse signal comprises a low-power, low-frequency pulse voltage having a predetermined or adaptive frequency and pulse width.

16. A method of increasing a voltage of a transmission gate in a high-speed switch, comprising:
generating a pulse signal at a predetermined or adaptive frequency and pulse width;
comparing the pulse signal with a predetermined reference voltage and outputting an enabling signal;
generating a clock signal at predetermined intervals in response to the generated enabling signal; and
increasing the voltage of the transmission gate in response to the generated clock voltage.

17. The method of claim 16, further comprising:
comparing an output voltage with a predetermined target voltage in response to the pulse signal; and
generating the clock signal in response to the comparison.

18. The method of claim 17, wherein generating the clock signal comprises generating a first clock signal having a first phase and a second clock signal having a second phase when the output voltage equals the target voltage.

19. The method of claim 16, wherein generating a pulse signal comprises generating a low-power, low-frequency pulse voltage.
